(19) United States
(12) Patent Application Publication
(10) Pub. No.: US 2006/0159352 A1
(43) Pub. Date: Jul. 20, 2006

(54) Method and apparatus for encoding a video sequence

(76) Inventors: Faisal Ishtiaq, Chicago, IL (US); Bhavan R. Gandhi, Vernon Hills, IL (US)

Correspondence Address: MOTOROLA, INC., 1303 EAST ALGONQUIN ROAD, IL01/3RD, SCHAUMBURG, IL, 60196, US

(21) Appl. No.: 11/038,318

(22) Filed: Jan. 18, 2005

(51) Int. Cl. G06K 9/36

(52) U.S. Cl. 382/236; 382/239

(57) ABSTRACT

A method and system for encoding a video sequence is provided that generates a temporally scalable video sequence comprising a plurality of frames. The method comprises classifying (102) a frame into a suitable class, the suitable class being selected from a set of predefined classes. Once a frame is classified, it is encoded (104) by means of a buffer, wherein the buffer includes separate storage for storing frames of different classes. A reconstructed version of the encoded frame is then stored (106) in the buffer. The method steps are iteratively repeated for each frame of the video sequence.

### FIELD OF THE INVENTION

The present invention relates in general to the field of video encoding, and more specifically to a video encoding method that generates a scalable video sequence.

### BACKGROUND

Digital video compression is used to reduce the data rate of a source video by generating an efficient and non-redundant representation of the original source video. Video encoding techniques known in the art, including ITU-T H.26X, ISO/IEC MPEG-1, MPEG-2, and MPEG-4 standards, perform video compression prior to transmitting the source video over a transmission channel.

Over the last decade, there has been a proliferation in the use of digital video. Currently, digital video is accessed by diverse types of clients using a variety of different systems, networks and mediums. These clients range from low bitrate, error-prone cell phone/PDAs, to cable modems connected via high-speed error-free T1 lines. Providing digital video to diverse clients necessitates flexible encoding techniques and adaptive delivery systems that service a high data rate client on an error-free channel as efficiently as a low data rate client on an error-prone channel. It is therefore important for a video encoder to generate bitstreams that are transmitted effectively to various types of clients without significant loss in compression efficiency.

Scalability is one of the main techniques employed in the art for addressing this issue of providing digital video to a diverse set of clients. The technique encodes enrichment data in additional enhancement layers that progressively result in better quality video. A scalability technique known in the art is temporal scalability, wherein enhancement layers provide progressively better temporal resolution as more layers are decoded. Scalability can also help in increasing the error resilience of the source video by applying different levels of error protection on the different layers. While scalability has been adopted within the recent H.263 and MPEG-4 standards, it has not been adopted in many existing video-encoding standards such as the H.264/MPEG-4 AVC standard.

### BRIEF DESCRIPTION OF THE DRAWINGS

The accompanying figures, where like reference numerals refer to identical or functionally similar elements throughout the separate views, and which, together with the detailed description below, are incorporated in and form a part of the specification, serve to further illustrate various embodiments and explain various principles and advantages, in accordance with the invention.

FIG. 1 is a flowchart depicting a method of encoding a video sequence, in accordance with some embodiments of the present invention;

FIG. 2 illustrates an encoding layout of the video sequence in accordance with an embodiment of the present invention;

FIG. 3 is a flow chart depicting a method for generating the video sequence, in accordance with some embodiments of the present invention;

FIG. 4 is a schematic diagram of a system for generating a video sequence, in accordance with some embodiments of the present invention; and

FIG. 5 illustrates a buffer, in accordance with some embodiments of the present invention.

Skilled artisans will appreciate that the elements in the figures are illustrated for simplicity and clarity, and have not necessarily been drawn to scale. For example, the dimensions of some of the elements in the figures may be exaggerated, relative to other elements, to help in enhancing the understanding of the embodiments of the present invention.

### DETAILED DESCRIPTION OF THE INVENTION

Before describing in detail a method and apparatus for encoding a video sequence, in accordance with the present invention, it should be observed that the present invention resides primarily in combinations of method steps and apparatus components related to encoding the video sequence. Accordingly, the apparatus components and method steps have been represented, where appropriate, by conventional symbols in the drawings. These drawings show only the specific details that are pertinent for an understanding of the present invention, so as not to obscure the disclosure with details that will be apparent to those with ordinary skill in the art and the benefit of the description herein.

The present invention provides a method and apparatus for encoding a video sequence, which generates a temporally scalable video sequence comprising a plurality of frames. According to an embodiment of the present invention, the method comprises classifying a frame into a suitable class, the suitable class being selected from a set of predefined classes. Once a frame is classified, it is encoded by utilizing a buffer, wherein the buffer includes separate storage for storing frames of different classes. A reconstructed version of the encoded frame is then stored in the buffer. The method steps are iteratively repeated for each frame of the video sequence.

The provided method is compliant with the H.264 video encoding standard, so that all normative H.264 decoders can accurately decode the generated bitstream. Hence, it enables temporal scalability to be employed within the H.264 standard, even though the standard itself does not explicitly support scalability. It should be noted that the present invention is not limited to the H.264 video encoding standard. All standards, using information from a previous frame and allowing for multiple frame storage, can employ this method to achieve temporal scalability.

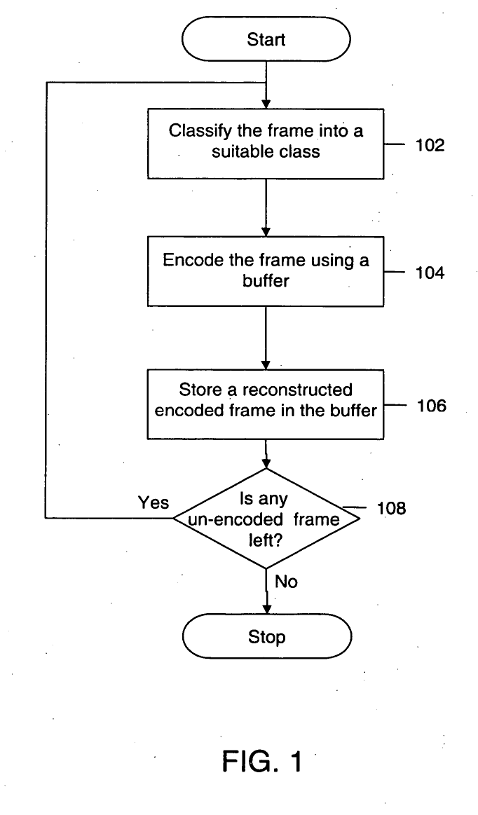

Referring to FIG. 1, a flow chart depicts a method for encoding a video sequence, in accordance with some embodiments of the present invention. The video sequence comprises a plurality of frames, that when presented in succession, generates a complete video. The plurality of frames is classified according to a plurality of temporal layers. The temporal layers comprise a base layer and at least one enhancement layer. The base layer represents the layer with the lowest temporal resolution, while each enhancement layer, when added to a base layer, represents a higher temporal resolution. Each temporal layer is also referred to as a class.

At step 102, a frame belonging to the video sequence is classified into a suitable class, wherein the suitable class is chosen from a set of predefined classes. The predefined classes refer to the layers (base layer and enhancement layers) defined in a particular implementation scheme.

In an embodiment, the classification of frames into classes is carried out, based on the bit rate of a transmission channel, through which the video sequence is sent and/or the desired temporal resolution of the video sequence. For example, consider a case wherein a video sequence has to be transmitted according to two frame rates. The first, at 30 frames per second (fps), is to be generated for transmission over a high bandwidth channel, and a second, at 10 fps, is to be generated for transmission over a wireless link. According to an embodiment of the present invention, every third frame of the video sequence is encoded (i.e., frames 0, 3, 6, 9, 12, 15, 18, 21, 24, 27 . . . ) in an exemplary class A, and the remaining frames (1, 2, 4, 5, 7, 8, 10, 11 . . . ) are encoded in an exemplary class B.

Alternatively, consider a case wherein two bitstreams need to be generated for the same video sequence at 2 Mbps and 768 Kbps, respectively. In accordance with an embodiment of the present invention, the frames are encoded in the two exemplary classes A and B. A subset of the frames is encoded in class A, to meet the 768 Kbps requirement (frames 0, 5, 7, 8, 10 . . . ), and another subset is encoded, comprising the other frames (frames 2, 3, 6, 9 . . . ) at 1232 Kbps.

At step 104, each frame of the video sequence is encoded using a buffer. The encoding of a frame results in the compression of the frame. The buffer includes storage for storing frames, corresponding to the classes to which the frames belong. In other words, frames belonging to different classes can be stored in designated locations within the buffer. For example, the frames classified as belonging to an exemplary class A are stored in a storage area designated for class A frames, and so on. One method to encode the frame is using the frame encoding methodology as defined in the H.264 video coding standard. In an embodiment of the invention, a buffer can be one contiguous piece of memory that is divided into different buffers for storing frames of different classes.

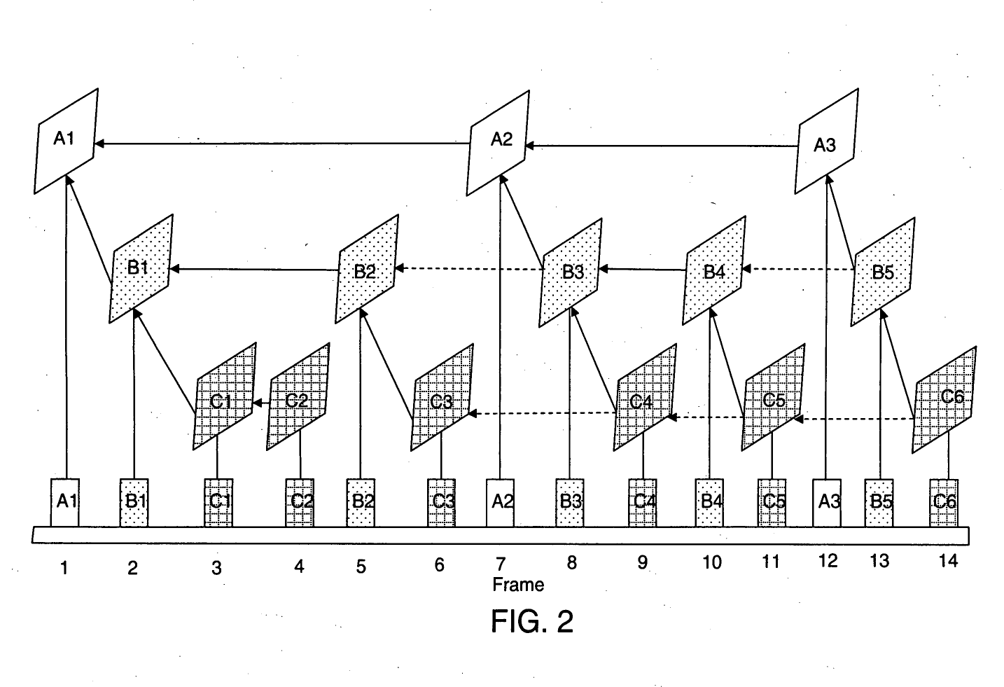

In accordance with an embodiment of the present invention, each frame is encoded by predicting the frame from a previously stored frame in the buffer. However, it should be noted that the first frame of the video sequence is encoded as an INTRA coded frame. An INTRA coded frame is encoded independently of any previously sent frames, and is therefore bandwidth consuming. The method of encoding frames, using stored frames in the buffer, is described in detail in conjunction with FIG. 2. The remaining frames encoded by prediction are INTER coded, since they are encoded by using previously encoded frames.

At step 106, a reconstructed version of each encoded frame is stored in the buffer. The reconstruction of an encoded frame refers to the decompression of the encoded frame. Reconstruction of INTRA frames do not require a reference frame for prediction. However, reconstruction of INTER frames do require one or more predictive frames from which a prediction of the frame currently being decoded is formed. In accordance with an embodiment of the invention, reconstructed frames from each appropriate class are stored in the appropriately designated buffers as long-term frames. A long-term frame is a frame that is stored for a long period of time in the buffer. The storage and removal of the long-term frame is signaled by commands sent within the video sequence. These commands can be sent as sequence of bits at specific times that, when received, instruct the decoding process to carry out a predefined set of buffer manipulations. In accordance with another embodiment of the invention, a frame can also be stored as a short-term frame. A short-term frame is a frame that is removed after a short period of time by either a new frame pushing the oldest short-term frame out, or by commands sent within the video sequence. Short-term frames are held for a shorter time period than long-term frames, and are used when a video sequence is to be sent in short intervals. A buffer, storing one or more long-term frames, is hereinafter referred to as a long-term buffer, and a buffer storing one or more short-term frames is referred to as a short-term buffer.

At step 108, it is determined if there are any frames remaining in the video sequence that need to be encoded. If there is a frame that has to be encoded, steps 102 to 108 are repeated. The stopping criteria is particular to the encoding scenario and can be based upon the desired bitrate, frame rate, or other factors that go into how the layers, or classes, are structured.

In accordance with an embodiment of the present invention, all the frames of the encoded video sequence can be stored at a single location, such as a database connected to a video server. This enables the video server to transmit the encoded video sequence later to various clients.

In accordance with another embodiment of the present invention, the maximum number of classes, and the method of classifying the frames, may be decided on prior to the encoding process, or during the encoding process. The maximum number of classes is dependent on the size of the buffer, and the number of frames per class held in the buffer. For instance, if N long-term buffers and at least one short-term buffer are available, and only one frame per class is held in the long-term buffer, the maximum number of classes allowed is N+1.

The working of the encoding method is described hereinafter with the help of an example. Referring to FIG. 2, an exemplary encoding layout of a video sequence is shown, in accordance with an embodiment of the invention. The frames of the video sequence are classified as belonging to one of the classes A, B or class C. In accordance with an embodiment of the invention, class A provides the lowest temporal resolution to the video sequence, and consequently requires the lowest bitrate for transmission. Class B enhances Class A's temporal resolution by adding more frames. However, as the temporal resolution of the frames increase, the required bitrate to transmit the encoded frames also increases. Finally, adding Class C frames to the class A and class B frames provides maximum resolution to the video sequence at the highest bitrate.

Consider a first frame 1 of the video sequence. Since the frame 1 is the first frame of the video sequence, it is encoded as an INTRA coded frame, classified as belonging to class A and referred to as frame A1. After encoding, the frame A1 is stored as a long-term frame in the long-term buffer known to contain class A prediction frames. The next source frame is a frame 2 that has been classified as belonging to class B and is referred to as frame B1. As the frame B1 is the first Class B frame, it can either be encoded as an INTRA frame, or predicted by using the frame A1. A frame that is used for the prediction of a successive frame is hereinafter referred to as a predictor frame. If the frame B1I is encoded as an INTRA frame, the dependency of frames in class B frames on class A frames is done away with, at a higher cost to compression efficiency. However, in accordance with an embodiment of the present invention, the frame B1 is encoded as an INTER frame, using the frame A1 as the predictor frame. Once the frame B1 is encoded, a reconstructed version of the frame B1 is stored as a long-term frame in the buffer in the storage area designated for class B frames.

The next frame in the video sequence, frame 3, is classified as belonging to class C and referred to as frame C1. The frame C1 is encoded as an INTER frame, using frame B1 as the predictor frame. The frame A1 can also be used as a predictor frame, but is less efficient, since the frame B1 is temporally closer to the frame C1 . After the frame C1 is encoded, it is stored as a long-term frame in the buffer designated for class C frames. The frames A1 and B1, belonging to classes A and B, respectively, and residing in the buffer, remain unaltered.

In accordance with an embodiment of the invention, frame 4 in the video sequence, referred to as frame C2, is predicted by using the frame C1, and is classified as belonging to class C. After being encoded, the frame C2 is stored as a long-term frame in the storage area designated for Class C frames in the buffer. This process is repeated in a similar fashion for the subsequent frames, i.e., frames B2, C3, A2, B3, C4, B4, Cs, A3, B5 and C6.

In accordance with an alternative embodiment of the invention, if the buffer's size restrictions do not allow for multiple long-term frames from the same class to be stored, the previous long-term frame from a class is removed, to allow the current frame of the same class to be stored in the buffer. For instance, the frame C1 may be removed from the buffer and replaced with the frame C2, if the buffer cannot store more than one frame in a storage area designated for a class.

In accordance with an embodiment of the invention, a predictor frame must belong to the same or previous class of frame that is being predicted, and must be available in the buffer. A frame belonging to a class is not dependent on a frame in any subsequent classes. For example, frame 5 in the video sequence, classified as belonging to class B and referred to as the frame B2, is encoded by using the frame B1 instead of the temporally closer frame C2. In accordance with an alternative embodiment of the present invention, the frame B2 is encoded by using the frame A1 for prediction, since the frame A2 belongs to a previous class and is available in the buffer. Therefore, a class B frame requires that the predictor frame is either in class B or in class A. The prediction of a frame belonging to class B is independent of any class C frame. Likewise, all frames from class A require only previous class A frames for encoding. Accordingly, frame 7 in the video sequence, referred to as frame A2, is predicted using the frame A1, and stored in the buffer in the storage area designated for class A frames. In accordance with an embodiment of the invention, frame 8, referred to as frame B3, is predicted by using the frame A2, since it is closer than the frame B2.

Similarly, frame 9 of the video sequence, referred to as frame C4, is predicted by using the frame B3 rather than the frame C3, since the frame B3 represents a temporally closer frame. In accordance with an alternative embodiment of the present invention, the frame C4 is predicted by using the frame C3, which lies in the same class, i.e., class C. This is indicated by the lines connecting the frames C4 and C3. However, predicting a frame by using a frame that is not temporally closer, but from the same class, satisfies the requirements of the method, in accordance with the invention, but may lead to lower encoding efficiency and decreased error resilience.

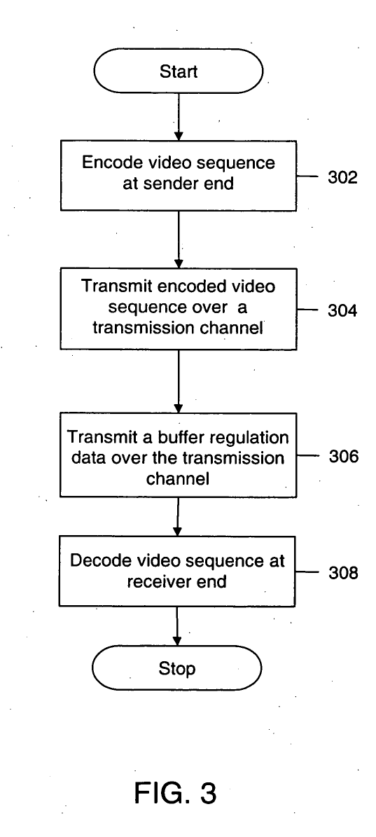

Referring to FIG. 3, a flow chart depicts a general method for generating a video sequence, in accordance with some embodiments of the present invention. Generating the video sequence includes encoding the video sequence at the sender end, transmitting the video sequence through a transmission channel, and decoding the transmitted video sequence at the receiver end.

At step 302, each frame of the video sequence is encoded according to the method described with reference to FIG. 1. The encoding is carried out at the sender end, from where the encoded video sequence is sent. At step 304, the encoded video sequence is transmitted over a transmission channel to the receiver end, which refers to the end where the decoding of the encoded video sequence takes place. In accordance with an embodiment of the present invention, the transmission channel is characterized by a certain bitrate, at which the encoded video sequence is transmitted, and the channel error profile. The channel error profile is a profile of the errors that occur during transmission of the video sequence over the transmission channel.

At step 306, a buffer regulation data is transmitted to the receiver end. The buffer regulation data includes information regarding regulation of the buffer storing the encoded frames. The buffer regulation data enables decoding of the encoded video sequence, to be carried out accurately at the receiver end. The buffer regulation data includes information about how the buffer is manipulated during the encoding process at step 302. For example, buffer regulation data may include information about initializing/configuring the buffer, altering the status of the buffer from a long-term buffer to a short-term buffer, and labeling a long-term buffer as being used or empty. The buffer regulation data includes buffer commands (related to manipulation of the buffer) that are transmitted to the receiver end, so that decoding can be carried out. Signaling of the buffer commands can be sent within the bitstream of the encoded video sequence, or communicated by external means as independent commands sent independently of the video sequence. A signaling methodology that allows sending the buffer regulation data is an integral part of the H.264 video encoding standard. In the H.264 video encoding standard, long-term and short-term buffers can be precisely regulated by the use of commands sent in the bitstream belonging to the encoded video sequence.

At step 308, the transmitted video sequence is decoded at the receiver end, using a decoder buffer. The decoder buffer is configured according to the buffer regulation data received at the receiver end. The buffer commands included in the buffer regulation data are applied to the decoder buffer during the decoding process.

Therefore, the decoder buffer state enables the accurate decoding of the encoded video sequence to be carried out, in the same manner in which the video sequence was encoded. The decoder buffer also stores the decoded frames according to their classification, and includes separate storage for different classes of the frames.

It should be noted that the transmission of video sequence refers to sending the encoded video sequence from the sender end to the receiver end. The sender end and the receiver end may be located at the same physical location or at different physical locations. Hence, in accordance with an alternative embodiment of the present invention, the encoded video sequence may be stored locally on a computer or a data processing device. Thereafter, one or more classes of the encoded video sequence can be decoded and played back, depending on the speed of the computer's processor and/or its computational or memory capacity.

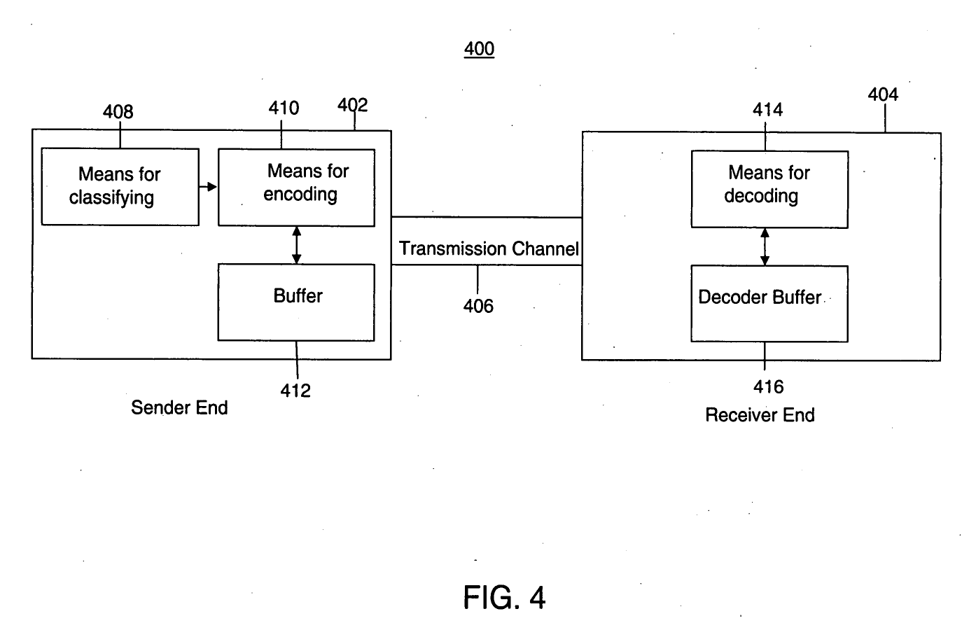

Referring to FIG. 4, a schematic diagram of a system 400 for generating a video sequence is shown, in accordance with some embodiments of the present invention. The system 400 includes a video encoder 402 located at a sender end, a video decoder 404 located at a receiver end, and a transmission channel 406. The video encoder 402 encodes the video sequence according to the method described with reference to FIG. 1. The video encoder 402 comprises a means for classifying 408, a means for encoding 410, and a buffer 412. The means for classifying 408 is used to classify each frame of the video sequence into a suitable class, according to the method described with reference to FIG. 1. The means for encoding 410 encodes the frame by predicting the frame, using a predictor frame stored in the buffer 412.

The buffer 412 enables the encoded frame to be stored according to the class to which the encoded frame belongs.

The encoded video sequence is transmitted through the transmission channel 406, which carries the encoded video sequence to the video decoder 404, located at a receiver end. Additionally, a buffer regulation data, as described with reference to FIG. 3, is also sent through the transmission channel 406. The transmission channel 406 may be among any transmission technologies that can enable transmission of the video sequence including fiber optic lines, coaxial networking cable, a wireless link, or a dedicated digital line such as T1 or T3.

The video decoder 404 decodes the transmitted video sequence according to the method described with reference to FIG. 3. The video decoder 404 comprises a means for decoding 414 and a decoder buffer 416. The means for decoding 414 decodes the transmitted video sequence according to the method described with reference to FIG. 3, using the buffer regulation data sent from the video encoder 402. Therefore, the decoder buffer 416 enables the decoding of the encoded video sequence to be carried out in the same manner in which the video sequence was encoded. The decoder buffer 416 stores the decoded frames according to their classes, and includes separate storage for different classes of the frames.

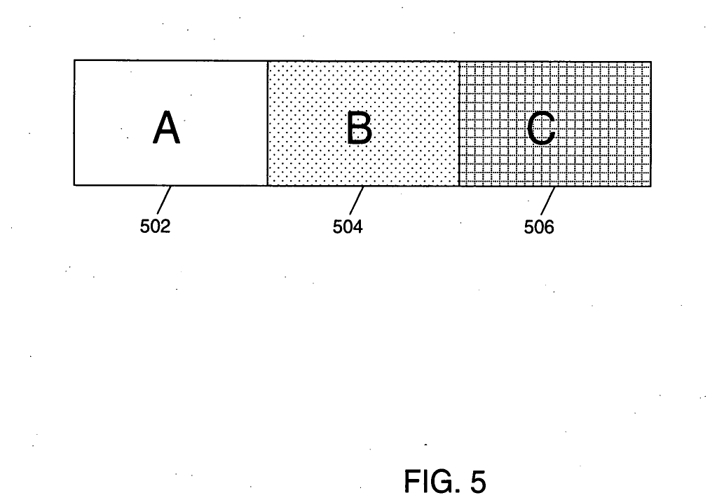

Referring to FIG. 5, a schematic diagram of a buffer 500, used to store a frame according to its class, is depicted, in accordance with some embodiments of the present invention. The buffer 500 is a contiguous memory storage comprising storage areas for storing frames according to their classification. A storage 502 stores frames belonging to class A. For example, reconstructed versions of all encoded frames belonging to class A are stored in the storage 502, designated for class A frames. Similarly, reconstructed versions of all encoded frames belonging to class B are stored in a storage 504 designated for class B frames, while reconstructed versions of all encoded frames classified as belonging to class C are stored in a storage 506 designated for class C frames

The method provided by the present invention offers resilient benefits similar to that of traditional scalability. This is achieved by applying Unequal Error Protection (UEP) to different classes. A video delivery system employing the encoding method can transmit a video sequence to diverse clients over different transmission channels, so that the clients receive the maximum amount of error-free data. For example, consider an encoded video sequence, in which the encoded frames are classified into three classes—A (base layer), B (enhancement layer) and C (enhancement layer). Class A frames are applied with large amounts of error protection schemes, to ensure that they are received uncorrupted over any transmission channel. Similarly, an error detection scheme can be applied in Class B frames, but no error detection/protection scheme is applied to Class C frames. If a transmission channel is error-free, the video delivery system can transmit all the encoded frames belonging to the three classes. If a transmission channel is severely corrupted, the video delivery system can then choose to transmit only Class A frames. The scalable nature of the video sequence allows a portion of the entire video to be received in a reasonably good quality.

In an embodiment of the present invention, the error resiliency of the encoded video sequence may be increased by introducing INTRA-coded frames in between the encoded video sequence. For example, referring to FIG. 2, consider a case where the frame A1 suffers from certain errors. Subsequent frames that are encoded, using the frame A1, including frames B1, C1, C2, B2 and C3, would all also suffer from the same errors. In this event, the frame A2 is introduced as an INTRA-coded frame, to stop the propagation of errors in the proceeding frames. Therefore, in accordance with an embodiment of the invention, INTRA-coded frames can be inserted periodically at the cost of encoding efficiency, to avoid error propagation that would adversely affect the quality of the video sequence.

The method provided by the present invention also enables each frame in a class to act as a reset frame for a frame in a successive class. For example, in FIG. 2, all class A frames represent reset points for succeeding class B frames, and all class B frames represent reset points for class C frames. This feature increases error resiliency without incurring the additional loss of encoding efficiency that occurs when an INTRA coded frame is introduced in the video sequence. These reset points serve the same purpose as INTRA-coded frames and are required when INTRA-coded frames cannot be used at regular intervals due to bitrate constraints in the transmission channel 404.

Various embodiments of the present invention benefit a variety of applications, including video encoding, video database, video browsing, surveillance, public safety, storage, and streaming applications. The division of the video sequence into classes ensures that its delivery can be regulated by a video delivery mechanism. The encoding method provided by the present invention generates a scalable video sequence that has increased error resiliency. This feature is especially useful in wireless video delivery where transmission channel errors and bitrate regulations are severe. In addition, the encoding method makes a video delivery system adaptable to the different transmission channel characteristics of diverse clients

Further, the video encoding methodology may be used in broadband applications, wherein a video delivery mechanism can be customized, based on the quality of service parameters, including revenue-based and priority-based deliveries, bandwidth-limited transmission, and ‘trailer’ mode, where only the lowest class is provided for the purpose of advertisement.

It will be appreciated that the video-encoding technique described herein may comprise one or more conventional processors and unique stored program instructions that control one or more processors, to implement some, most, or all of the functions described herein. As such, the functions of encoding the frame, using a buffer, and decoding the frame, may be interpreted as being steps of a method. Alternatively, the same functions could be implemented by a state machine that has no stored program instructions, in which each function, or some combinations of certain portions of the functions, are implemented as custom logic. A combination of the two approaches could be used. The methods and means of performing these functions have been described herein.

In the foregoing specification, the present invention and its benefits and advantages have been described with reference to specific embodiments. However, one with ordinary skill in the art will appreciate that various modifications and changes can be made, without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as a critical that is required, or essential features or elements of any or all of the claims.

As used herein, the terms ‘comprises’, ‘comprising,’ or any other variation thereof, are intended to cover a non-exclusive inclusion, so that a process, method, article, or apparatus that comprises a list of elements does not include only those elements but may include other elements not expressly listed or inherent in such a process, method, article or apparatus.

A ‘set’, as used herein, means an empty or non-empty set (i.e., for the sets defined herein, comprising at least one member). The term ‘another’, as used herein, is defined as at least a second or more. The term ‘having’, as used herein, is defined as comprising. The term ‘program’, as used herein, is defined as a sequence of instructions designed for execution on a computer system. A ‘program’ or ‘computer program” may include a subroutine, a function, a procedure, an object method, an object implementation, an executable application, an applet, a servlet, a source code, an object code, a shared library/dynamic load library, and/or other sequences of instructions designed for execution on a computer system. It is further understood that the use of relational terms, if there are any, such as first and second, top and bottom, etc., are used solely to distinguish one entity or action from another entity or action, without necessarily requiring or implying any actual relationship or order between such entities or actions.

1. A method for encoding a video sequence, the video sequence comprising a plurality of frames, the method comprising iteratively performing the following for each frame:
classifying the frame into a suitable class, the suitable class being chosen from a set of predefined classes;
encoding the frame using a buffer, the buffer including separate storage for storing frames of different classes; and
storing a reconstructed version of the encoded frame in the buffer.

2. The method according to claim 1, wherein the buffer includes storage for at least one long-term frame.

3. The method according to claim 1, wherein the buffer includes storage for at least one short-term frame.

4. The method according to claim 1, wherein encoding the frame is implemented according to INTRA coding.

5. The method according to claim 1, wherein encoding the frame is implemented according to INTER coding.

6. The method according to claim 5, wherein encoding the frame comprises predicting the frame using a previously encoded frame stored in the buffer, the previously encoded frame being related to either the suitable class or a previous class.

7. The method according to claim 6, wherein the previously encoded frame is temporally closest to the frame.

8. The method according to claim 1, wherein the classification of the frame into a suitable class is performed using at least one of a desired temporal resolution of the video sequence and a desired bitrate for the different classes.

9. The method according to claim 1 further comprising storing the encoded video sequence for future use.

10. A method for generating a video sequence, the video sequence being encoded at a sender end and decoded at a receiver end, the video sequence comprising a plurality of frames, the method comprising:
encoding the video sequence at the sender end by iteratively performing the following for each frame:
classifying the frame into a suitable class, the suitable class being chosen from a set of predefined classes;
encoding the frame using a buffer, the buffer including separate storage for storing frames of different classes; and
storing a reconstructed version of the encoded frame in the buffer;
transmitting at least one frame belonging to the encoded video sequence from the sender end to the receiver end over a transmission channel;
transmitting a buffer regulation data from the sender end to the receiver end over the transmission channel, the buffer regulation data including information about regulation of the buffer; and
decoding the video sequence at the receiver end by using a decoder buffer, the decoder buffer being configured according to the buffer regulation data.

11. The method according to claim 10, wherein the buffer includes storage for at least one long-term frame.

12. The method according to claim 10, wherein the buffer includes storage for at least one short-term frame.

13. The method according to claim 10, wherein encoding the frame is implemented according to FNTRA coding.

14. The method according to claim 10, wherein encoding the frame is implemented according to INTER coding.

15. The method according to claim 14, wherein encoding the frame comprises predicting the frame using a previously encoded frame stored in the buffer, the previously encoded frame being related to either the suitable class or a previous class.

16. The method according to claim 15, wherein the previously encoded frame is temporally closest to the frame.

17. The method according to claim 10, wherein the classification of the frame into a suitable class is performed using at least one of a desired temporal resolution of the video sequence and a desired bitrate for the different classes.

18. An apparatus suitable for encoding a video sequence, the video sequence comprising a plurality of frames, the video encoder comprising:
means for classifying each frame into a suitable class, the suitable class being chosen from a set of predefined classes;
means for encoding the frame using a buffer, the buffer including separate storage for storing frames of different classes; and
means for storing a reconstructed version of the encoded frame in the buffer.

19. The apparatus according to claim 18, wherein the number of predefined classes depends on at least one of:
capacity of the buffer; and
number of frames per class held in the buffer.
